(19) United States
(12) Patent Application Publication
(10) Pub. No.: US 2011/0182062 A1
(43) Pub. Date: Jul. 28, 2011

(54) Tactical Modular Light Adapter

(76) Inventor: D. Anthony Wilson, (US)

(21) Appl. No.: 12/695,174

(22) Filed: Jan. 28, 2010

(51) Int. Cl. F21L 4/00

(52) U.S. Cl. 362/197

(57) ABSTRACT

A Flashlight adapter which is placed between the two pre-existing ends of a previously separated flashlight thereby allowing the intended direction of the beam to be pointed or located in an entirely different direction then was originally intended before the adapter was installed. The installation of the adapter causes the bulb and bulb housing of the flashlight to face in an entirely different direction or position rather than in the position it was facing when attached directly to its previous other half. The modular adapter also includes additional seals and contact pins which provide waterproofing and stable continuous contact of the batteries in the body of the light assembly to the bulb in the head. In one embodiment the modular adapter has an additional switch included in the top of the unit for additional convenience and lighting control. In another embodiment, the modular adapter has a large rear clip allowing for secure attachment to clothing or equipment providing the complete unit with additional support while being carried on ones person.

### CROSS REFERENCE TO RELATED APPLICATIONS

### U.S. Patent Documents

U.S. Pat. No. 4,357,648 * November 1982 Nelson . . . 362/183
U.S. Pat. No. 4,408,263 * October 1983 Sternlicht . . . 362/189
U.S. Pat. No. 4,441,142 * April 1984 Garofalo . . . 362/158
U.S. Pat. No. 4,725,932 * February 1988 Gammache . . . 362/202
U.S. Pat. No. 4,949,231 * August 1990 Wang et al. . . . 362/206
U.S. Pat. No. 5,036,444 * July 1991 Hiles . . . 362/188
U.S. Pat. No. 5,117,341 * May 1992 Huang et al. . . . 362/184
U.S. Pat. No. 5,121,308 * June 1992 Maglica et al. . . . 362/187
U.S. Pat. No. 5,287,255 * February 1994 Strodtman . . . 362/102
U.S. Pat. No. 5,309,337 * May 1994 Groben . . . 362/206
U.S. Pat. No. 5,317,490 * May 1994 Miller . . . 362/206
U.S. Pat. No. 5,353,208 * October 1994 Moore . . . 362/202
U.S. Pat. No. 5,400,227 * March 1995 Maglica et al. . . . 362/206
U.S. Pat. No. 5,463,541 * October 1995 Greene . . . 362/369
U.S. Pat. No. 5,499,172 * March 1996 Shiau . . . 362/187
U.S. Pat. No. 5,667,293 * September 1997 Own . . . 362/184
U.S. Pat. No. 6,283,609 * September 2001 Parsos, Keller, Reeves . . . 362/187
U.S. Pat. No. 6,786,615 * September 2004 Hendricks . . . 362/109

### BACKGROUND OF THE INVENTION

1) Field of Invention

The Invention is generally related to flashlights, and is more specifically related to tactical flashlights which are used by law-enforcement officers and military personnel to enhance ease of use particularly while performing advanced law-enforcement tactical training procedures.

2) Description of the Prior Art

Tactical Flashlights are commonly known and have been heavily utilized by law enforcement and military personnel in the execution of their duties. During such use, the flashlight operator may be required to position and point their light using a variety of tactical maneuvers while at the same time carefully controlling a firearm or lesser lethal devices.

During these tactical procedures, the officer or soldier must, maintain control of their tactical flashlight, carefully aiming it in an effort to either illuminate the path ahead of them or the person or thing they are intending to target. Normally during such a procedure, an officer may be required to utilize just a few of his or her fingers in an effort to keep control and operation of the tactical flashlight with one hand while maintaining a firearm firmly affixed in the other.

While performing these tactical maneuvers, the officer or soldier may in fact be subjected to other unforeseen conditions which may cause extra stress on his or her fingers, thereby risking a drop of the light or misapplication of the beam of the light. This misapplication may inadvertently cause the light to be flashed in fellow officers eyes causing temporary vision impairment or inadvertently disclosing the hidden positions of other personnel in the area and thereby placing others at risk.

In other instances, should the light be dropped, it may often roll away from the officer or soldier, placing them at risk during its discovery and retrieval. Another drawback to prior art tactical flashlights, especially those which are shaped in the standardize tubular or shaft design, is that both officers and soldiers which have suffered hand and wrist injury in the line of duty may in fact not be physically capable of performing the standard tactical light operational maneuvers which require the operator to use contorted wrist or finger positions in an effort to maintain both flashlight positioning and operation. This limitation makes the standardized tubular design of the flashlight non compliant with the needs and requirements of those with even minor hand and wrist disabilities. Prior art tactical flashlights are composed of a cylindrical body containing normally between one and three small batteries, and a head area which contains the bulb and reflector assembly. The body of the tactical light is generally not much longer than the palm of ones hand, and normally is attached to the slightly larger in diameter tactical head, wherein the bulb is located. A switch is commonly located in the rear of the light which when slightly depressed, activates the light in a momentary or on-off action then activating the light to illuminate accordingly.

The law enforcement officer is often trained to carry out tactical maneuvers by placing the light between two fingers and drawing the lights end-cap, wherein is located the switch, into contact with the palm-pad area of his or her thumb-palm muscle in an effort to activate the tactical light while holding it in a manner much reminiscent of the way one would hold a cigar. Other types of maneuvers require the light to be held by all fingers firmly, in a fingers-down position while heavily bending the wrist in an effort to hold the light aimed directly before the chest, while shinning out away from the officer.

These tactical positions may be required to be held in place for as long as and even longer than 15 minutes during stand-off conditions in real-life applications. The locations of the on-off activation switch in prior art tactical lights limits the offices ability to control the light with one hand as required under modern law enforcement tactical training guidelines, both due to the shape of the prior art tactical lights and the position of the activation switch in the base of the tubular design.

Based upon the prior art tactical flashlights, it would be desirable if a durable tactical modular adapter could be installed that would position the light in the operators hand in such a way which allow him or her to have both control and stability while allowing the operator to firmly grip the light with all or as few as one finger. This additional support would also allow for secure control and focus of the light during unexpected conditions such as close confrontations, as the light would be easily gripped with the entire group of capable fingers instead of being held between just a few fingers in an awkward manner.

Additionally, the addition of a tactical modular light adapter would allow officers with hand and wrist injuries to engage in the tactical use of their light without further stress or injury to their wrists.

The addition of the on-off button on the top of the tactical modular adapter allows for quick and convenient access and control of the tactical light while holding the complete assembly in a natural, thumb-up position.

### BRIEF SUMMARY OF THE INVENTION

Tactical Flashlights are often utilized by both military and law enforcement personnel in the execution of their duties. During these duties, both officer and soldier alike, carry a variety of devises upon their persons for the purposes of the mission they are sent in to accomplish. Some of these devices include hand-held firearms, batons, knives, and tactical flashlights.

Most commonly, during night patrols where close confrontations may be expected, the standard choice of devices to carry for tactical purposes is a hand-held firearm and tactical light.

The subject invention is specifically directed to a tactical modular light adapter for use by law enforcement personnel and military. The Tactical modular light adapter is comprised of a rectangular shaped body with a threaded opening in the bottom and a threaded shaft in the upper side. These threaded areas allow for the tactical modular light adapter to be placed in between the head and body of any compatible tactical flashlight, allowing for the light to be more easily handled and controlled for safer use under the adverse conditions which a law enforcement officer or soldier may encounter.

An additional center spring and pin system in the center of the adapter allows for a firm connection from the batteries contained in the body of the prior art tactical light, through to the center pin output of the adapter, and then to the bulb in the existing head of the prior art tactical light. This center spring and contact-pin design also allows for prevention of light flashing during operation while under jarring conditions, should the light be dropped while in the on position.

In this invention, a clip is added to the adapter to allow for the entire light-adapter assembly to be mounted into tactical vests and jackets which were designed to carry forward facing lights. The squared corners allow the flashlight-adapter combination to be rested upon flat objects such as tables, counters, and other flat surfaces, without worry of rolling. The flat sided shape also provides stability with holster mounting and convenience when officers hold the assembly under their arm pit as is common in during traffic citation duty, and thereby free their hands to accomplish the other tasks which their job may require such as holding and filing out citation materials.

The L-shape which is created by the use of the tactical modular light adapter also allows for the light to be turned on and used for pathway illumination while still mounted in a standard law enforcement tactical light holster thereby entirely freeing the officer to utilize his or her arms and hands for other tasks required when conducting searches or investigations. Additionally, the L-shape and flat sides allow the unit to be held in a standard tactical nylon web holster and mounted to horse saddles, providing trail illumination during off-road search and rescue operations. This advantage of trail illumination, free the officer to utilize other lighting equipment to search in the off-trail locations while their trail-horse safely maneuvers in the off-road environment.

In this invention, by converting the light into a non-roll-able L-shape, and repositioning the light in a more natural and comfortable position, the addition of the tactical modular light adapter further eliminates the potential hazard of light recovery due to a drop-and-roll scenario and provides both safety and fast recovery should the light be dropped.

The additional grip provided by the added tactical light adapter module invention, to a prior art tactical flashlight, also provides the officer or soldier with a tool which can easily be used as a small baton during unexpected close impact situations where suitable force may be required. The heavy duty metal construction of the invention provides additional structural integrity and weight to the complete tactical light and adapter apparatus thereby increasing its use as an emergency baton.

The addition of a top mounted button gives added control of the on-off operation of the light during tactical procedures in a manner most easily accessible to officers and military personnel thereby increasing the usability and functionality of the entire assembly.

In one embodiment the modular adapter has the switch included in the back of the adapter, replacing the back-mounted clip. In another embodiment the switch is removed entirely in order to allow the assembly to be laid upside down on a flat surface and pointed at a fixed objects, thereby allowing an officer to aim the light at a target and walk behind the illuminated area unseen by the targeted individual who can only see the beam of light. This additional configuration further provides both the officer and soldier the safety advantage by making one operator appear to be two individuals. The light could be set firmly on a vehicle and aimed at a suspect while the officer or soldier circles around in the area behind the light which is not viewable to the suspect and thereby provide both the officer and soldier a key tactical advantage and an increase in personal safety.

The switch utilized in the adapter is of the pushbutton type, yet is designed to have an exceptionally silent operation. The switch is sealed in the adapter chassis utilizing a unique switch cover that is integrally formed of a bowl shaped section and seals to a water-resistant to water-proof level. In another embodiment of this invention, a switch is positioned in the back of the unit to allow for personnel with shorter palms and or fingers to comfortably utilize the tactical light-adapter combination, providing greater safety when utilizing tactical maneuvers. This rear-mounted switch embodiment also allows for other mounting configurations to be added to the top of the adapter for greater tactical use.

The forward section of the Tactical modular light adapter invention is threaded in order to allow for the bulb-carrying end of a tactical light to be threaded onto it. It has oring seals which allow for the overall waterproofing qualities of the tactical light to be maintained.

The bottom end of the tactical modular light adapter has internal threads with a machined smooth surface to accommodate the existing seals on the body of the tactical light which seals into it.

Another embodiment of the design reverses the threads on the forward section of the adapter to allow for tactical flashlight heads with external threads and tactical flashlight bodies with internal thread designs.

While particular embodiments of the invention have been herein illustrated and described, it is not intended to limit the invention to such disclosures, but changes and modifications may be made therein and thereto within the scope of the following claims.

Other further objects and advantages will appear from the following written description taken with the drawings, which show several embodiments. However, the drawings and written description are intended as preferred examples, and not as limitations on the scope of the invention. The invention resides as well as sub combinations of the elements described. The features, elements and methods described relative to one embodiment may also be used in the other embodiments.

### BRIEF DESCRIPTION OF THE SEVERAL VIEWS OF THE DRAWING

FIG. 1 is a cut-away side view of a prior art tactical flashlight head assembly with an internal bulb, which has been separated from its body, FIG. 3, in order to show placement of the tactical modular light adapter invention. FIG. 2.

FIG. 2 is a cut-away side view perspective of the tactical modular light adapter invention, placed in position between FIG. 1 and FIG. 3 for perspective.

FIG. 3 is a cut-away side view of a prior art tactical flashlight body assembly which has been separated from its head, FIG. 1, in order to show placement of the tactical modular light adapter invention, FIG. 2.

FIG. 4 is an exploded perspective of the tactical modular light adapter invention.

FIG. 5 is a cut-away side view of a prior art tactical flashlight body and head assembly with the invention installed in between.

FIG. 6 is an environmental view of the invention.

### DETAILED DESCRIPTION OF THE INVENTION

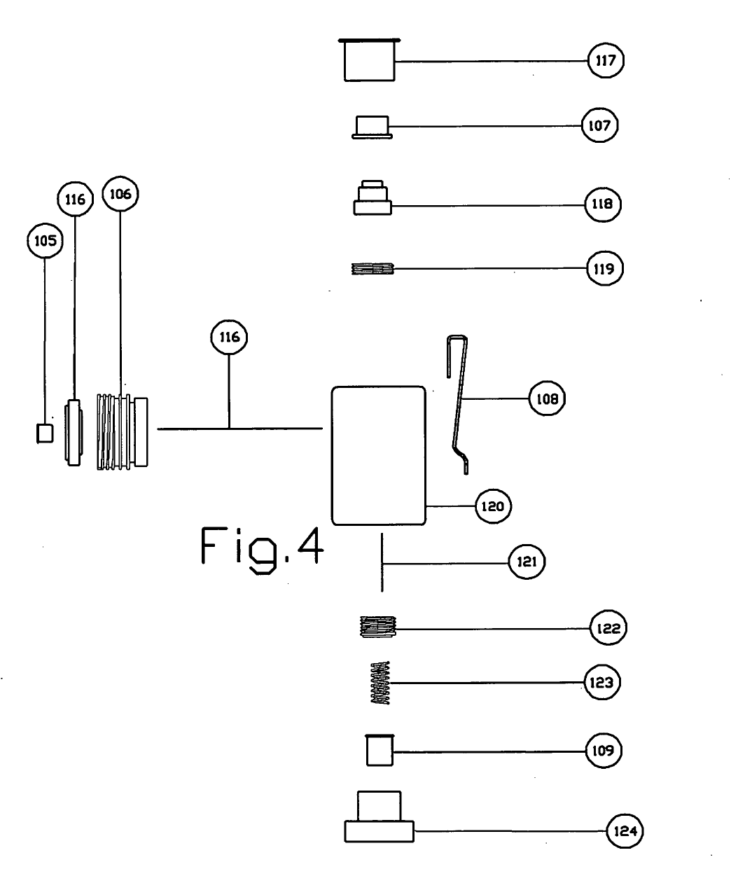

With reference to FIGS. 1, 2, 3 and 4 the tactical modular flashlight adapter of the present invention is shown and designated as 126; The prior art tactical flashlight body is shown and designated as 113; The prior art tactical flashlight head is shown and designated as 103.

Tactical modular light adapter 126, is generally comprised of an aluminum housing 120, a threaded head mount 106, a covered switch assembly 118, a threaded body mount 110, and a pocket clip 108.

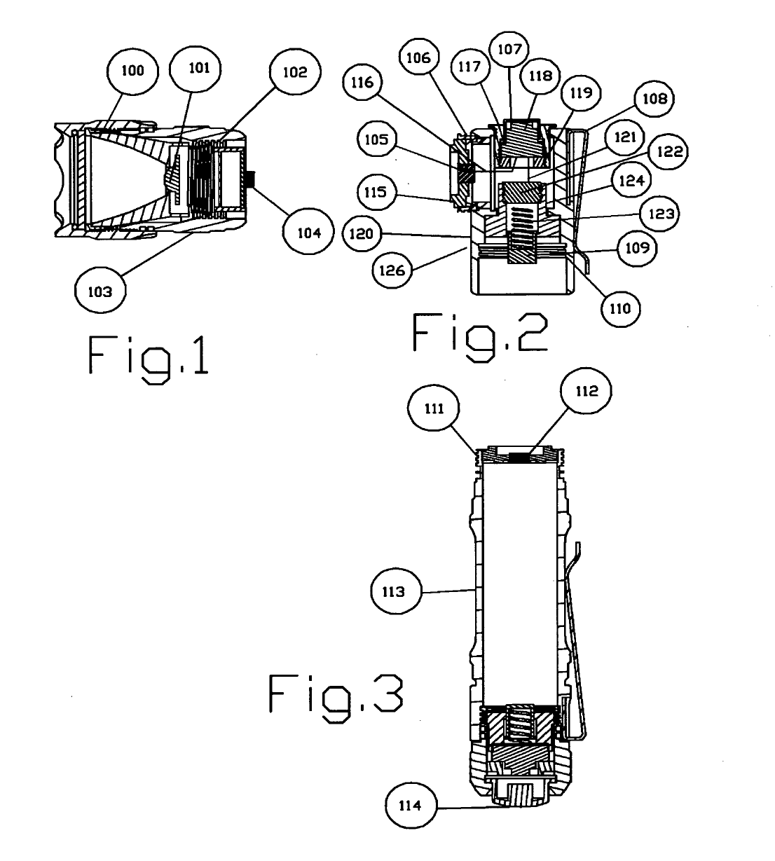

A protected switch assembly cover 107 is supplied and retained by retainer 117, to provide both sealing and waterproofing. Adjustment spacer 119, allows for height adjustment of switch assembly 118, in this embodiment of the invention. Threaded body mount 110, of the invention 126, FIG. 2, mates to threaded mount 111, of prior art tactical flashlight body FIG. 3, thereby providing electrical conductivity through to the body of prior art tactical flashlight 113, FIG. 3. Threaded mount 106 of the invention 126 FIG. 2, mates with prior art tactical flashlight head mount threads 102, FIG. 1, thereby allowing the invention conductive pin 105, to make electrical contact with prior art tactical flashlight conductive pin 104, so that power may be ultimately conducted to prior art tactical flashlight bulb 101, FIG. 1, causing a volume of light to be reflected from prior art tactical flashlight reflector 100.

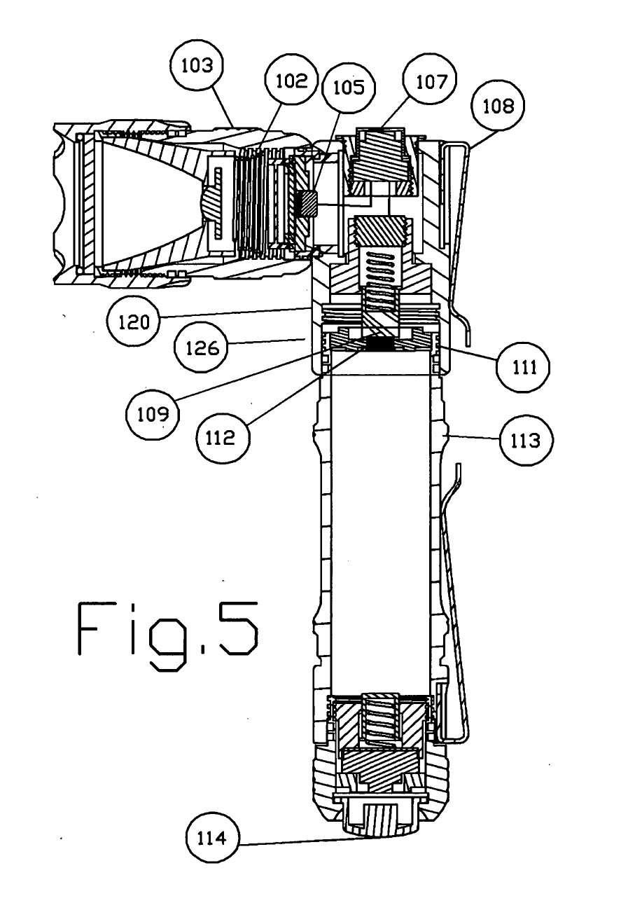

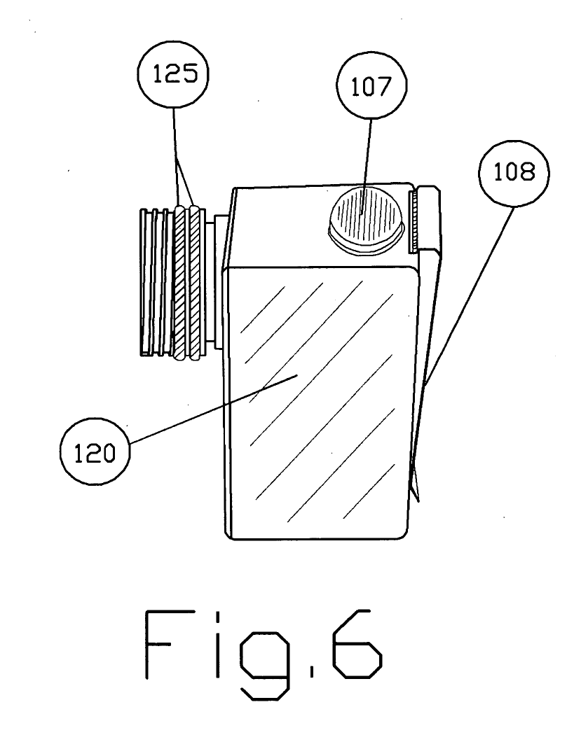

In the preferred embodiment of the invention 126, one side of wire 116, is affixed to conductive pin 105, whilst the other end of wire 116 is affixed to switch assembly 118. An additional wire 121, of the invention, connects from the other side of switch assembly 118, to contact spring mount 122. Spring mount and conductivity pin retainer 124 retains spring mount 122, while also retaining conductivity pin 109 in the main body of the invention. Spring 123, is positioned against spring mount 122, in order to provide electrical conductivity from spring mount 122, to conductivity pin 109. In addition, spring 123 provided anti-shock characteristics to conductivity pin 109 allowing for conductivity pin 109 to keep in constant contact with contact pin 112 of prior art tactical flashlight body FIG. 3. Having described the structural characteristics of the present invention, attention is now turned to the advantageous operational characteristics derived therefrom. Referring to FIG. 5 and FIG. 6.

FIG. 5 shows the tactical modular light adapter invention 126, connected in between the head 103, and body 113, of a prior art tactical flashlight, with 2 added O rings 125, for additional weather proofing.

As discussed above, the prior art tactical flashlight body 113, can easily be gripped securely with multiple fingers providing a relaxed and comfortable positioning of the officer's wrist while pointing the prior art tactical flashlight head and bulb assembly 103, in the forward direction during tactical use. Additionally, the rubber switch button 107, FIG. 5 and FIG. 6, of the invention 126 can easily be reached and depressed bye the officer's thumb.

In other embodiments, a switch assembly is located in place of the pocket clip 108 location, providing officers with smaller or shorter thumbs ease of use. As shown in FIG. 5, the complete assembly of both halves of the prior art tactical flashlight 103 and 113, combined with the tactical modular light adapter would allow the unit to be laid down without rolling, or mounted in either a holster or tactical vest for hands-free operation while pointing in the direction aimed. The above described tactical modular light adapter provides additional protection to prior art tactical flashlights to which it is connected. This is accomplished by incorporating spring and contact pins which make contact with the body conductor and or batteries. In the event the light should be dropped, the spring and pin system in the tactical modular light adapter absorbs much of the shock caused by batteries moving within the body of the light on applicable prior art tactical flashlight models. Another unique feature to the tactical modular light adapter is the optional placement of the switch. Whether top mounted or rear mounted, the assemblies provide nearly silent, push button operation of the flashlight, and the switches function in two ways having both momentary activation position, and a continuous on-off position. The switch is also covered by a water-resistant and heat-resistant cover which makes it of greater value to individuals working in high temperature or wet environments such as firefighters. While certain features and embodiments of the invention have been described in detail herein, it will be readily understood that the invention encompasses all modifications and enhancements within the scope and spirit of the following claims.

What is claimed is:

1. A tactical modular light adapter assembly for adapting in between the head and body of a tactical flashlight for the purpose of changing the direction of the head of the tactical flashlight from the direction of the battery-containing body of the tactical flashlight, the tactical modular adapter further comprising:
a chassis housing for supporting a cylindrical tactical flashlight head mount on one end of the adapter, and the battery-containing body barrel of the tactical flashlight on the other end;
a switch assembly in the adapter housing;
a set of seals which weather-proof the head to adapter connection;
a contact pin in the center of the head mount to provide electrical contact from the adapter to the bulb in the head of the tactical light;
a spring mount in the center of the chassis, to provide electrical conductivity and mounting of the contact spring;
a spring seat retainer to provide retention of the spring seat; while electrically insulating it from the chassis;
a spring, to absorb shock transferred to the conductivity pin, and to conduct electricity from the conductivity pin to the spring seat;
a conductivity pin, to make contact with the tactical light body center contact and battery assembly, wherein the center conductor is electrically insulated from the tactical modular light adapter chassis.
a conductivity pin and spring mount retainer, to retain the spring mount and the bottom conductivity pin while electrically insulating the pin, spring, and spring mount from the chassis of the adapter assembly;

2. The tactical modular light adapter assembly of claim 1, wherein said switch is mounted directly into the tactical modular light adapter body.

3. The tactical modular light adapter assembly of claim 1, wherein the switch assembly includes a switch activation element extending vertically through the top of the assembly housing.

4. The tactical modular light adapter assembly of claim 1, wherein the switch assembly includes a switch activation element extending through the top back corner of the assembly housing.

5. The tactical modular light adapter assembly of claim 1, the switching element having an activator push button accessible by the thumb, through the wall of the assembly, wherein the activator button includes a flexible membrane button cover which may be selectively moved into contact with the activator when the switch button is depressed.

6. The tactical modular light adapter assembly of claim 1, the switch element comprising a quiet action push button switch.

7. The tactical modular light adapter assembly of claim 6, the switch element push button feature is inclusive of a primary activated position wherein the switch is in an intermittent-on or momentary position when the button is slightly depressed to engage the first level, and with additional pressure placed upon the button, the switch element locks into the full-on position.
